(19) United States
(12) Patent Application Publication
(10) Pub. No.: US 2026/0220751 A1
(43) Pub. Date: Jul. 30, 2026

(54) ENHANCED IMAGE RESOLUTION FOR KNOWN NON-SYMMETRIC POINT SPREAD FUNCTIONS

(71) Applicant: Raytheon Company, Arlington, VA (US)

(72) Inventors: Jonathan Aaron Cain, Tucson, AZ (US); Yu Wang, Tucson, AZ (US)

(21) Appl. No.: 19/038,377

(22) Filed: Jan. 27, 2025

(51) Int. Cl. G06T 5/80; G06T 5/73

(52) U.S. Cl. CPC G06T 5/80; G06T 5/73

(57) ABSTRACT

A method comprises receiving a detected image distorted by environmental conditions, obtaining asymmetric point spread function (PSF) data associated with the detected image, applying modified nearest neighbor pixel deconvolution (MNNPD) to detected image responsive to the asymmetric PSF data and generating a processed image from the detected image modified to limit distortion of the detected image and having an increased resolution responsive to the applied MNNPD.

### TECHNICAL FIELD

This disclosure relates generally to image enhancement. More specifically, this disclosure relates to enhanced image resolution for known non-symmetric point spread functions.

### BACKGROUND

Image enhancement is often a useful or important function for astronomy, defense, or other imaging applications. For example, finer details of scenes can be smeared, and these finer details may not be recognized by the sensor pixels of the optical sensor. This can result in a loss of detail in the captured images. Inverse filtering is one common approach for image enhancement. Many inverse filtering techniques require point spread function (PSF) data to be symmetric. Other approaches are also often designed for symmetric PSF data, such as Weiner filters and nearest neighbor pixel deconvolution (NNPD), but do not necessarily require it. Furthermore, generalized inverse filters often assume noise has a Gaussian shape, which is not always true for non-symmetric PSFs.

In the real world, the PSF is usually not symmetric especially for situations such as missile camera imaging, under water imaging, etc. When taking images through turbulent air of a missile in flight, taking images through smog, taking images underwater, taking images with low cost non-perfect cameras or taking images using missile cameras having jitter motions, the PSF may become distorted and no longer have a symmetric shape.

### SUMMARY

This disclosure relates to enhanced image resolution for known non-symmetric point spread functions.

In some examples, a method includes receiving a detected image distorted by environmental conditions, obtaining asymmetric point spread function (PSF) data associated with the detected image, applying modified nearest neighbor pixel deconvolution (MNNPD) to detected image responsive to the asymmetric PSF data and generating a processed image from the detected image modified to limit distortion of the detected image and having an increased resolution responsive to the applied MNNPD.

Any single one or any combination of the following features may be used with the examples above. The method wherein applying further may include determining the PSF data for each pixel responsive to the MNNPD. The asymmetric PSF data further may include PSF data where data values located around a central pixel of the PSF data each have different values. The method wherein applying further may include applying the MNNPD according to a formula:

$${Δ}_{lm} = {a}_{0} + {Δ}_{lm} ( 1 ) + {Δ}_{lm} ( 2 ) + {Δ}_{lm} ( 3 ) + {Δ}_{lm} ( 4 ) + …$$

$$Where :$$

$${Δ}_{lm} ( 1 ) = a {1}_{1 , 0} {e}^{- i 2 π \frac{l}{N}} + a {1}_{0 , 1} {e}^{- i 2 π \frac{m}{N}} + a {1}_{- 1 , 0} {e}^{i 2 π \frac{l}{N}} + a {1}_{0 , - 1} {e}^{i 2 π \frac{m}{N}}$$

$${Δ}_{lm} ( 2 ) = a {2}_{1 , 1} {e}^{- i 2 π \frac{l + m}{N}} + a {2}_{- 1 , - 1} {e}^{i 2 π \frac{l + m}{N}} + a {2}_{1 , - 1} {e}^{- i 2 π \frac{l - m}{N}} + a {2}_{- 1 , 1} {e}^{i 2 π \frac{l - m}{N}}$$

$${Δ}_{lm} ( 3 ) = a {3}_{2 , 0} {e}^{- i 2 π \frac{2 l}{N}} + a {3}_{0 , 2} {e}^{- i 2 π \frac{2 m}{N}} + a {3}_{- 2 , 0} {e}^{i 2 π \frac{2 l}{N}} + a {3}_{0 , - 2} {e}^{i 2 π \frac{2 m}{N}}$$

$${Δ}_{lm} ( 4 ) = a {4}_{2 , 1} {e}^{- i 2 π \frac{2 l + m}{N}} + a {4}_{1 , 2} {e}^{- i 2 π \frac{l + 2 m}{N}} + a {4}_{- 2 , - 1} {e}^{i 2 π \frac{2 l + m}{N}} + a {4}_{- 1 , - 2} {e}^{i 2 π \frac{l + 2 m}{N}} + a {4}_{2 , - 1} {e}^{- i 2 π \frac{2 l - m}{N}} + a {4}_{1 , - 2} {e}^{- i 2 π \frac{l - 2 m}{N}} + a {4}_{- 2 , 1} {e}^{i 2 π \frac{2 l - m}{N}} + a {4}_{- 1 , 2} {e}^{i 2 π \frac{l - 2 m}{N}}$$

a₀, a1ᵢⱼ, a2ᵢⱼ, . . . are neighboring pixel correlation coefficients, N is a number of pixels and l is a number of Fourier components in an x direction and m is a number of Fourier components in a y direction.
   The method wherein applying further may include determining a pixel value for each pixel of the detected image using MNNPD and applying the determined pixel value for each pixel to an associated pixel of the detected image. The method wherein generating further may include generating the processed image responsive to the pixel value applied to each associated pixel of the detected image. The method may include displaying the processed image having the increased resolution.

In other examples, a system includes an imaging system configured to capture an input image, where the input image is associated with asymmetric PSF data. The system also includes at least one processing device configured to receive a detected image distorted by environmental conditions, obtain asymmetric point spread function (PSF) data associated with the detected image, apply modified nearest neighbor pixel deconvolution (MNNPD) to detected image responsive to the asymmetric PSF data, and generate a processed image from the detected image modified to limit distortion of the detected image and having an increased resolution responsive to the applied MNNPD.

Any single one or any combination of the following features may be used with the examples above. The system wherein the at least one processing device is further configured to determine the PSF data for each pixel responsive to the MNNPD. The at least one processing device further configured to apply further may include applying the MNNPD according to a formula:

$${Δ}_{lm} = {a}_{0} + {Δ}_{lm} ( 1 ) + {Δ}_{lm} ( 2 ) + {Δ}_{lm} ( 3 ) + {Δ}_{lm} ( 4 ) + …$$

$$Where :$$

$${Δ}_{lm} ( 1 ) = a {1}_{1 , 0} {e}^{- i 2 π \frac{l}{N}} + a {1}_{0 , 1} {e}^{- i 2 π \frac{m}{N}} + a {1}_{- 1 , 0} {e}^{i 2 π \frac{l}{N}} + a {1}_{0 , - 1} {e}^{i 2 π \frac{m}{N}}$$

$${Δ}_{lm} ( 2 ) = a {2}_{1 , 1} {e}^{- i 2 π \frac{l + m}{N}} + a {2}_{- 1 , - 1} {e}^{i 2 π \frac{l + m}{N}} + a {2}_{1 , - 1} {e}^{- i 2 π \frac{l - m}{N}} + a {2}_{- 1 , 1} {e}^{i 2 π \frac{l - m}{N}}$$

$${Δ}_{lm} ( 3 ) = a {3}_{2 , 0} {e}^{- i 2 π \frac{2 l}{N}} + a {3}_{0 , 2} {e}^{- i 2 π \frac{2 m}{N}} + a {3}_{- 2 , 0} {e}^{i 2 π \frac{2 l}{N}} + a {3}_{0 , - 2} {e}^{i 2 π \frac{2 m}{N}}$$

$${Δ}_{lm} ( 4 ) = a {4}_{2 , 1} {e}^{- i 2 π \frac{2 l + m}{N}} + a {4}_{1 , 2} {e}^{- i 2 π \frac{l + 2 m}{N}} + a {4}_{- 2 , - 1} {e}^{i 2 π \frac{2 l + m}{N}} + a {4}_{- 1 , - 2} {e}^{i 2 π \frac{l + 2 m}{N}} + a {4}_{2 , - 1} {e}^{- i 2 π \frac{2 l - m}{N}} + a {4}_{1 , - 2} {e}^{- i 2 π \frac{l - 2 m}{N}} + a {4}_{- 2 , 1} {e}^{i 2 π \frac{2 l - m}{N}} + a {4}_{- 1 , 2} {e}^{i 2 π \frac{l - 2 m}{N}}$$

a₀, a1ᵢⱼ, a2ᵢⱼ, . . . are neighboring pixel correlation coefficients, N is a number of pixels and l is a number of Fourier components in an x direction and m is a number of Fourier components in a y direction.
   The asymmetric PSF data further may include PSF data where data values located around a central pixel of the PSF data each have different values. The at least one processing device is further configured to determine a pixel value for each pixel of the detected image using MNNPD and apply the determined pixel value for each pixel to an associated pixel of the detected image. The at least one processing device is further configured to generate the processed image responsive to the pixel value applied to each associated pixel of the detected image. The at least one processing device is further configured to display the processed image having the increased resolution.

In still other examples, a non-transitory machine readable medium containing instructions that when executed cause at least one processor to receive a detected image distorted by environmental conditions. The instructions also include cause the at least one processor to obtain asymmetric point spread function (PSF) data associated with the detected image. The instructions also include cause the at least one processor to apply modified nearest neighbor pixel deconvolution (MNNPD) to detected image responsive to the asymmetric PSF data. The instructions also include cause the at least one processor to generate a processed image from the detected image modified to limit distortion of the detected image and having an increased resolution responsive to the applied MNNPD.

Any single one or any combination of the following features may be used with the examples above. The non-transitory machine readable medium further containing instructions that when executed cause the at least one processor to determine the PSF data for each pixel responsive to the MNNPD. The non-transitory machine readable medium further containing instructions that when executed cause at least one processor to apply the MNNPD according to a formula:

$${Δ}_{lm} = {a}_{0} + {Δ}_{lm} ( 1 ) + {Δ}_{lm} ( 2 ) + {Δ}_{lm} ( 3 ) + {Δ}_{lm} ( 4 ) + …$$

$$Where :$$

$${Δ}_{lm} ( 1 ) = a {1}_{1 , 0} {e}^{- i 2 π \frac{l}{N}} + a {1}_{0 , 1} {e}^{- i 2 π \frac{m}{N}} + a {1}_{- 1 , 0} {e}^{i 2 π \frac{l}{N}} + a {1}_{0 , - 1} {e}^{i 2 π \frac{m}{N}}$$

$${Δ}_{lm} ( 2 ) = a {2}_{1 , 1} {e}^{- i 2 π \frac{l + m}{N}} + a {2}_{- 1 , - 1} {e}^{i 2 π \frac{l + m}{N}} + a {2}_{1 , - 1} {e}^{- i 2 π \frac{l - m}{N}} + a {2}_{- 1 , 1} {e}^{i 2 π \frac{l - m}{N}}$$

$${Δ}_{lm} ( 3 ) = a {3}_{2 , 0} {e}^{- i 2 π \frac{2 l}{N}} + a {3}_{0 , 2} {e}^{- i 2 π \frac{2 m}{N}} + a {3}_{- 2 , 0} {e}^{i 2 π \frac{2 l}{N}} + a {3}_{0 , - 2} {e}^{i 2 π \frac{2 m}{N}}$$

$${Δ}_{lm} ( 4 ) = a {4}_{2 , 1} {e}^{- i 2 π \frac{2 l + m}{N}} + a {4}_{1 , 2} {e}^{- i 2 π \frac{l + 2 m}{N}} + a {4}_{- 2 , - 1} {e}^{i 2 π \frac{2 l + m}{N}} + a {4}_{- 1 , - 2} {e}^{i 2 π \frac{l + 2 m}{N}} + a {4}_{2 , - 1} {e}^{- i 2 π \frac{2 l - m}{N}} + a {4}_{1 , - 2} {e}^{- i 2 π \frac{l - 2 m}{N}} + a {4}_{- 2 , 1} {e}^{i 2 π \frac{2 l - m}{N}} + a {4}_{- 1 , 2} {e}^{i 2 π \frac{l - 2 m}{N}}$$

a₀, a1ᵢⱼ, a2ᵢⱼ, . . . are neighboring pixel correlation coefficients, N is a number of pixels and l is a number of Fourier components in an x direction and m is a number of Fourier components in a y direction.
   The non-transitory machine readable medium further containing instructions that when executed cause the at least one processor to determine a pixel value for each pixel of the detected image using MNNPD and apply the determined pixel value for each pixel to an associated pixel of the detected image. The non-transitory machine readable medium further containing instructions that when executed cause the at least one processor to generate the processed image responsive to the pixel value applied to each associated pixel of the detected image. The non-transitory machine readable medium further containing instructions that when executed cause the at least one processor to display the processed image having the increased resolution.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example system supporting image enhancement of digital pixels for an imaging device or other device having asymmetric point spread function (PSF) data according to this disclosure;

FIG. 2 illustrates symmetric PSF according to this disclosure;

FIG. 3 illustrates non-symmetric PSF according to this disclosure;

FIG. 4 illustrates an example of symmetric PSF data according to this disclosure;

FIG. 5 illustrates an example of asymmetric PSF data according to this disclosure;

FIG. 6 illustrates an example of generating a processed image from a blurred image according to this disclosure; and

FIG. 7 illustrates an example process for generating an enhanced image according to this disclosure.

### DETAILED DESCRIPTION

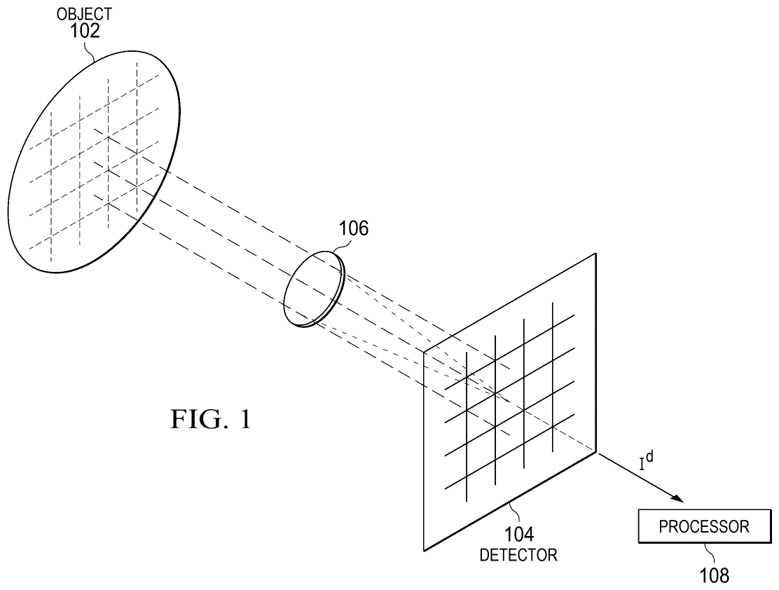

FIGS. 1 through 7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

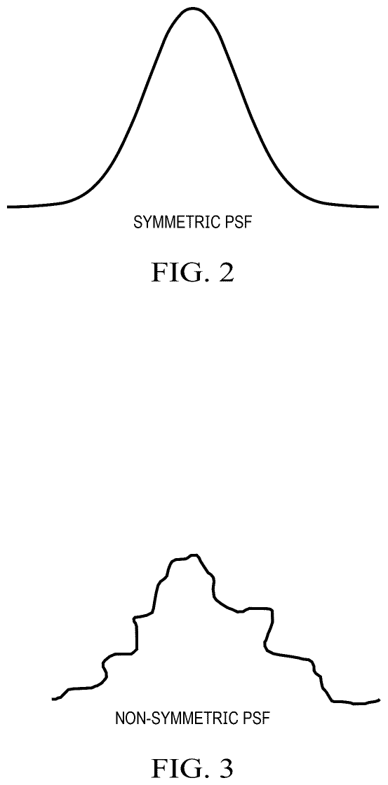

Referring now to FIG. 1, there is illustrated a general diagram of an apparatus for the detection of an image of an object 102 using a detector 104 to generate a detected image I^{d} wherein the image is captured by the detector 104 through an aperture 106. Image enhancement processing is carried out by an associated processor 108. Image enhancement of the detected image I^{d} is important for military and astronomy imaging as referenced above. Many of these imaging processing methods require the use of the point spread function (PSF) in order to be symmetric. The nearest neighbor pixel deconvolution (NNPD) is a powerful method for enhancing image resolution but will only work for images having a circular symmetric PSF is generally illustrated in FIG. 2.

As referenced above, in certain imaging applications the PSF may become distorted and no longer have asymmetric shape. These distortions are caused by environmental conditions such as air flow past a missile or underwater conditions that impact the aspheric or conformal optics that are used to image an object. The image of the object will thus be distorted by these atmospheric conditions. In these cases, a nonsymmetric PSF is provided as illustrated in FIG. 3. By modifying the in NPD with a modified nearest neighbor pixel model (MNNPM) a new deconvolution method may be established called modified nearest neighbor pixel deconvolution (MNNPD). MNNPD enables the image processing to operate with nonsymmetric PSF as illustrated in FIG. 3. While MNNPD may be used with the problem of NNPD with images having nonsymmetric PSF, such it may extend to other image processing methods with nonsymmetric PSF.

In general, a detected image I^{d} can be written as a convolution of the object image I^{o} and the PSF without noise:

$${I}^{d} = {I}^{o} * PSF$$

The original object image I^{o} may be recovered using a Fourier Transform (FT) and the convolution theorem. This provides:

$${F}^{d} = {F}^{o} \cdot Δ and {F}^{0} = {F}^{d} / Δ$$

Here F^{o}, F^{d} and A re the Fourier Transform of I^{o}, I^{d} and PSF, respectively.

The nearest neighbor pixel model (NNPD) regroups pixels with respect to the center PSF pixel. Additional details regarding the use of NNPD, on which MNNPD is based, are described in U.S. Pat. No. 7,912,307, which is hereby incorporated by reference in its entirety. The following presents a general overview of NNPD.

Using the NNPD model, pixels can be regrouped with respect to their distance from a center PSF pixel a₀. In some cases, this can be expressed as follows.

$${I}_{jk}^{d} = {a}_{0} {I}_{jk}^{0} + {a}_{1} {\sum }_{1}^{{N}_{1}} ( 1 {st}_{{nearest}_{neighbor}} ) + {a}_{2} {\sum }_{1}^{{N}_{2}} ( 2 {nd}_{{nearest}_{neighbor}} ) ++ {a}_{p} {\sum }_{1}^{{N}_{p}} ( {pth}_{{nearest}_{neighbor}} ) + …$$

Here, a₀, a₁, a₂, . . . are called the neighbor pixel correlation coefficients (NPCCCs). These values can be used to define the following.

$$PSF = {a}_{0} {δ}_{i , j} + {a}_{1} ( {δ}_{i , j + 1} + {δ}_{i , j - 1} + {δ}_{i + 1 , j} + {δ}_{i - 1 , j} ) + {a}_{2} ( {δ}_{i + 1 , j + 1} + {δ}_{i + 1 , j - 1} + {δ}_{i - 1 , j = 1} + {δ}_{i - 1 , j - 1} ) + …$$

Here, δᵢⱼ, δ_{i,j+1}, . . . are Kronecker delta functions. A Fourier transform can be defined as follows.

$$Object : {F}_{lm}^{0} = \frac{1}{N} {\sum }_{j = 0}^{N - 1} {\sum }_{k = 0}^{N - 1} {I}_{jk}^{0} {e}^{- 2 π i ( \frac{jl + km}{N} )}$$

$$Detector : {F}_{lm}^{d} = \frac{1}{N} {\sum }_{j = 0}^{N - 1} {\sum }_{k = 0}^{N - 1} {I}_{jk}^{d} {e}^{- 2 π i ( \frac{jl + km}{N} )}$$

Using the Shift theorem of the Fourier transform, the equation F^{d}=F^{o}·Δ becomes:

$${F}_{lm}^{d} = {F}_{lm}^{0} [ {a}_{0} + {a}_{1} ( {e}^{\frac{2 π im}{N}} + {e}^{\frac{- 2 π im}{N}} + {e}^{\frac{2 π il}{N}} + {e}^{\frac{- 2 π il}{N}} ) + {a}_{2} ( {e}^{2 π i \frac{( l + m )}{N}} + {e}^{- 2 π i \frac{( l + m )}{N}} + {e}^{2 π i \frac{( l - m )}{N}} + {e}^{- 2 π i \frac{( l - m )}{N}} ) + … ]$$

$$Or {F}_{lm}^{0} \frac{{F}_{lm}^{d}}{\begin{matrix}[ {a}_{0} + 2 {a}_{1} ( cos \frac{2 π m}{N} + cos \frac{2 π l}{N} ) + \\ 2 {a}_{2} [ cos \frac{2 π ( l + m )}{N} + cos \frac{2 π ( l - m )}{N} ] + … ]\end{matrix}}$$

Finally, by applying an inverse Fourier Transform to the above formula, a pixel of a recovered object image

$${I}_{jk}^{0}$$

can be expressed as follows.

$${I}_{{j}_{k}}^{0} = \frac{1}{N} {\sum }_{l = 0}^{N - 1} ( {\sum }_{m = 0}^{N - 1} \text{?} \frac{{F}_{lm}^{d}}{{Δ}_{lm}} {e}^{2 π i \frac{( jl + km )}{N}} ) \text{?}$$

### Here,

$${I}_{jk}^{0}$$

is the pixel of the processed image at position (j,k), F^{d}lₘ is the Fourier Transform component of the detected image, N is the total number of pixels in a row/column of a square array, a₀, a₁, a₂ . . . are the nearest neighbor correlation coefficients, and

$${Δ}_{lm} = {a}_{0} + {a}_{1} \cdot 2 [ cos ( \frac{2 π l}{N} ) + cos ( \frac{2 π m}{N} ) ] + {a}_{2} \cdot 2 [ cos ( 2 π \frac{l + m}{N} ) + cos ( 2 π \frac{l - m}{N} ) ] + …$$

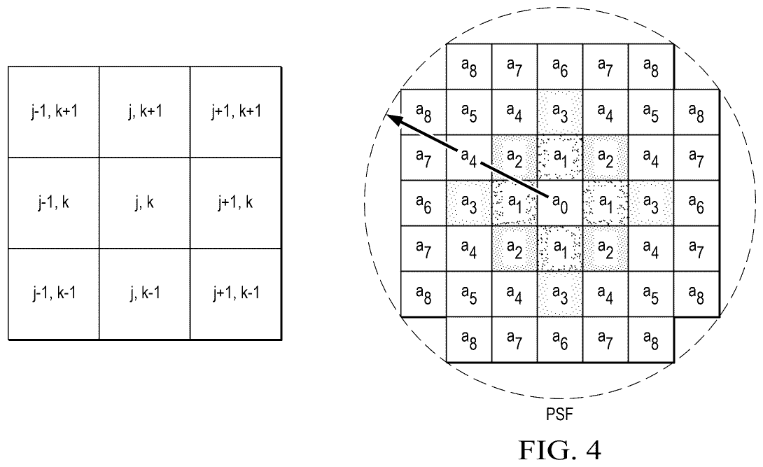

Here, pixels of the same order of nearest neighbor groups have the same value and thus represent symmetric data as shown in FIG. 4. Where Δₗₘ is the Optical Transfer Function (OTF), which is the Fourier Transfer of the PSF.

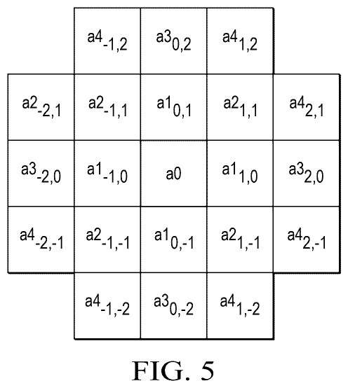

In other cases, the PSF is not symmetric, an example of which is shown in FIG. 5. For example, the pixels of the first-order group of nearest neighbor pixels includes a1_{-1,0} on the west side of a₀, a1_{0,1} on the north side of a₀, a1_{1,0} on the east side of a₀, and a1_{0,-1} on the south side of a₀ each having different values around the center pixel a₀. In these cases, the old NNPD method cannot be used to enhance the image, but MNNPD may be used to enhance the images. The calculation is more complex since cosine functions cannot be used, but a complex form like e^{2πiθ} can be used to solve the problem.

In NNPD, the image enhancement uses the formula for

$${I}_{{j}_{k}}^{0}$$

symmetric data. It the PSF is not symmetric MNNPD is used to enhance the image. The calculations cannot use cosine functions anymore but instead uses a complex form like e^{2πiθ} to solve the problem. For non-symmetric PSF data, the formula for

$${I}_{{j}_{k}}^{0}$$

is still valid, but the formula for Δₗₘ may be replaced with the following:

$${Δ}_{lm} = {a}_{0} + {Δ}_{lm} ( 1 ) + {Δ}_{lm} ( 2 ) + {Δ}_{lm} ( 3 ) + {Δ}_{lm} ( 4 ) + …$$

$$Where :$$

$${Δ}_{lm} ( 1 ) = a {1}_{1 , 0} {e}^{- i 2 π \frac{l}{N}} + a {1}_{0 , 1} {e}^{- i 2 π \frac{m}{N}} + a {1}_{- 1 , 0} {e}^{i 2 π \frac{l}{N}} + a {1}_{0 , - 1} {e}^{i 2 π \frac{m}{N}}$$

$${Δ}_{lm} ( 2 ) = a {2}_{1 , 1} {e}^{- i 2 π \frac{l + m}{N}} + a {2}_{- 1 , - 1} {e}^{i 2 π \frac{l + m}{N}} + a {2}_{1 , - 1} {e}^{- i 2 π \frac{l - m}{N}} + a {2}_{- 1 , 1} {e}^{i 2 π \frac{l - m}{N}}$$

$${Δ}_{lm} ( 3 ) = a {3}_{2 , 0} {e}^{- i 2 π \frac{2 l}{N}} + a {3}_{0 , 2} {e}^{- i 2 π \frac{2 m}{N}} + a {3}_{- 2 , 0} {e}^{i 2 π \frac{2 l}{N}} + a {3}_{0 , - 2} {e}^{i 2 π \frac{2 m}{N}}$$

$${Δ}_{lm} ( 4 ) = a {4}_{2 , 1} {e}^{- i 2 π \frac{2 l + m}{N}} + a {4}_{1 , 2} {e}^{- i 2 π \frac{2 l + m}{N}} + a {4}_{- 2 , - 1} {e}^{i 2 π \frac{2 l + m}{N}} + a {4}_{- 1 , - 2} {e}^{i 2 π \frac{l + 2 m}{N}} + a {4}_{2 , - 1} {e}^{- i 2 π \frac{2 l - m}{N}} + a {4}_{1 , - 2} {e}^{- i 2 π \frac{l - 2 m}{N}} + a {4}_{- 2 , 1} {e}^{i 2 π \frac{2 l - m}{N}} + a {4}_{- 1 , 2} {e}^{i 2 π \frac{l - 2 m}{N}}$$

a₀, a1ᵢⱼ, a2ᵢⱼ, . . . are the neighboring pixel correlation coefficients, Nis the number of pixels and l is the number of Fourier components in the x direction and m is the number of Fourier components in the y direction.

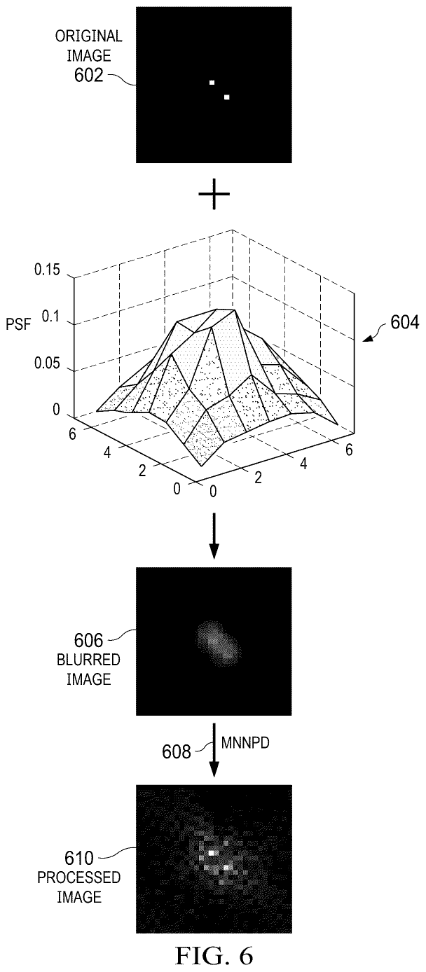

Referring now to FIG. 6, there is illustrated an example by which a second image blurred by asymmetric PSF may be processed using MNNPD. The original image 602 comprises two bright spots. When this image is processed by nonsymmetric PSF 604 the detected image comprises a blurred image 606. The blurred image merely illustrates a smeared cloud where in the two bright spots are no longer distinct within the picture. If a blurred image 606 is processed using MN in the techniques 608 the two bright spots are again visible in the process image 610.

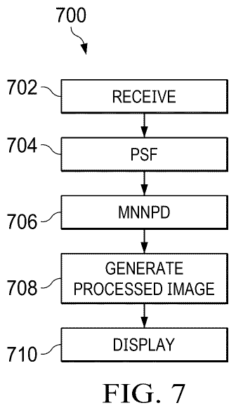

Referring now to FIG. 7, there is illustrated a flow diagram of the method for processing an image using MNNPD. The process 200 for applying enhanced image resolution to detected image data including asymmetric PSF using modified neighbor pixel deconvolution (MNNPD) according to this disclosure. This process 200 can build higher-resolution images processing detected images of objects including asymmetric point spread function (PSF) data. As shown in FIG. 7, PSF data for an input image is received at step 702. This may include, for example, the processor 108 obtaining the asymmetric PSF data from the detector 104 or other imaging system.

The asymmetric PSF data is obtained at step 704 by the processor 108 for the detected image. The MNNPD processing is applied to the image and PSF data at step 706. This involves the determination of a pixel value for each pixel of the detected image using MNNPD and applying the determined pixel values to each pixel of the detected image. The processed image is than generated at step 708 responsive to the MNNPD processing of the detected image and the processed image is generated at step 710.

Although FIG. 7 illustrates one example of a process 700 for applying enhanced image resolution to image data using MNNPD, various changes may be made to FIG. 7. For example, while shown as a series of steps, various steps in FIG. 7 may overlap, occur in parallel, occur in a different order, or occur any number of times.

Note that the use of MNNPD for non-symmetric PSF data due to aspheric or conformal optics, hypersonic optical effects, or other causes can enable improved image enhancement. The described techniques can find use in a number of applications. For example, MNNPD may be used for enhanced resolution for high-dynamic range (HDR) electro-optical/infrared sensing. MNNPD can be used to provide a computationally efficient inverse filter when compared with existing techniques. MNNPD allows for high performance customization (like application to non-symmetric PSF due to conformal optics) without a cost to computation time as needed by inverse filters in general.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving a detected image distorted by environmental conditions;
obtaining asymmetric point spread function (PSF) data associated with the detected image;
applying modified nearest neighbor pixel deconvolution (MNNPD) to detected image responsive to the asymmetric PSF data; and
generating a processed image from the detected image modified to limit distortion of the detected image and having an increased resolution responsive to the applied MNNPD.

2. The method of claim 1, wherein applying further comprises determining the PSF data for each pixel responsive to the MNNPD.

3. The method of claim 1, wherein applying further comprises:
applying the MNNPD according to a formula:
$${Δ}_{lm} = {a}_{0} + {Δ}_{lm} ( 1 ) + {Δ}_{lm} ( 2 ) + {Δ}_{lm} ( 3 ) + {Δ}_{lm} ( 4 ) + …$$
$$where :$$
$${Δ}_{lm} ( 1 ) = a {1}_{1 , 0} {e}^{- i 2 π \frac{l}{N}} + a {1}_{0 , 1} {e}^{- i 2 π \frac{m}{N}} + a {1}_{- 1 , 0} {e}^{i 2 π \frac{l}{N}} + a {1}_{0 , - 1} {e}^{i 2 π \frac{m}{N}}$$
$${Δ}_{lm} ( 2 ) = a {2}_{1 , 1} {e}^{- i 2 π \frac{l + m}{N}} + a {2}_{- 1 , - 1} {e}^{i 2 π \frac{l + m}{N}} + a {2}_{1 , - 1} {e}^{- i 2 π \frac{l - m}{N}} + a {2}_{- 1 , 1} {e}^{i 2 π \frac{l - m}{N}}$$
$${Δ}_{lm} ( 3 ) = a {3}_{2 , 0} {e}^{- i 2 π \frac{2 l}{N}} + a {3}_{0 , 2} {e}^{- i 2 π \frac{2 m}{N}} + a {3}_{- 2 , 0} {e}^{i 2 π \frac{2 l}{N}} + a {3}_{0 , - 2} {e}^{i 2 π \frac{2 m}{N}}$$
$${Δ}_{lm} ( 4 ) = a {4}_{2 , 1} {e}^{- i 2 π \frac{2 l + m}{N}} + a {4}_{1 , 2} {e}^{- i 2 π \frac{2 l + m}{N}} + a {4}_{- 2 , - 1} {e}^{i 2 π \frac{2 l + m}{N}} + a {4}_{- 1 , - 2} {e}^{i 2 π \frac{l + 2 m}{N}} + a {4}_{2 , - 1} {e}^{- i 2 π \frac{2 l - m}{N}} + a {4}_{1 , - 2} {e}^{- i 2 π \frac{l - 2 m}{N}} + a {4}_{- 2 , 1} {e}^{i 2 π \frac{2 l - m}{N}} + a {4}_{- 1 , 2} {e}^{i 2 π \frac{l - 2 m}{N}}$$
where a₀, a1ᵢⱼ, a2ᵢⱼ, . . . are neighboring pixel correlation coefficients, N is a number of pixels and l is a number of Fourier components in an x direction and m is a number of Fourier components in a y direction.

4. The method of claim 1, wherein the asymmetric PSF data further comprises PSF data wherein data values located around a central pixel of the PSF data each have different values.

5. The method of claim 1, wherein applying further comprises:
determining a pixel value for each pixel of the detected image using MNNPD; and
applying the determined pixel value for each pixel to an associated pixel of the detected image.

6. The method of claim 5, wherein generating further comprises generating the processed image responsive to the determined pixel value applied to each associated pixel of the detected image.

7. The method of claim 1, further comprising displaying the processed image having the increased resolution.

8. A system comprising:
an imaging system configured to capture an input image, the input image associated with asymmetric point spread function (PSF) data; and
at least one processing device configured to:
receive a detected image distorted by environmental conditions;
obtain asymmetric point spread function (PSF) data associated with the detected image;
apply modified nearest neighbor pixel deconvolution (MNNPD) to detected image responsive to the asymmetric PSF data; and
generate a processed image from the detected image modified to limit distortion of the detected image and having an increased resolution responsive to the applied MNNPD.

9. The system of claim 8, wherein the at least one processing device is further configured to determine the PSF data for each pixel responsive to the MNNPD.

10. The system of claim 8, wherein the at least one processing device is further configured to:
apply the MNNPD according to a formula:
$${Δ}_{lm} = {a}_{0} + {Δ}_{lm} ( 1 ) + {Δ}_{lm} ( 2 ) + {Δ}_{lm} ( 3 ) + {Δ}_{lm} ( 4 ) + …$$
$$where :$$
$${Δ}_{lm} ( 1 ) = a {1}_{1 , 0} {e}^{- i 2 π \frac{l}{N}} + a {1}_{0 , 1} {e}^{- i 2 π \frac{m}{N}} + a {1}_{- 1 , 0} {e}^{i 2 π \frac{l}{N}} + a {1}_{0 , - 1} {e}^{i 2 π \frac{m}{N}}$$
$${Δ}_{lm} ( 2 ) = a {2}_{1 , 1} {e}^{- i 2 π \frac{l + m}{N}} + a {2}_{- 1 , - 1} {e}^{i 2 π \frac{l + m}{N}} + a {2}_{1 , - 1} {e}^{- i 2 π \frac{l - m}{N}} + a {2}_{- 1 , 1} {e}^{i 2 π \frac{l - m}{N}}$$
$${Δ}_{lm} ( 3 ) = a {3}_{2 , 0} {e}^{- i 2 π \frac{2 l}{N}} + a {3}_{0 , 2} {e}^{- i 2 π \frac{2 m}{N}} + a {3}_{- 2 , 0} {e}^{i 2 π \frac{2 l}{N}} + a {3}_{0 , - 2} {e}^{i 2 π \frac{2 m}{N}}$$
$${Δ}_{lm} ( 4 ) = a {4}_{2 , 1} {e}^{- i 2 π \frac{2 l + m}{N}} + a {4}_{1 , 2} {e}^{- i 2 π \frac{2 l + m}{N}} + a {4}_{- 2 , - 1} {e}^{i 2 π \frac{2 l + m}{N}} + a {4}_{- 1 , - 2} {e}^{i 2 π \frac{l + 2 m}{N}} + a {4}_{2 , - 1} {e}^{- i 2 π \frac{2 l - m}{N}} + a {4}_{1 , - 2} {e}^{- i 2 π \frac{l - 2 m}{N}} + a {4}_{- 2 , 1} {e}^{i 2 π \frac{2 l - m}{N}} + a {4}_{- 1 , 2} {e}^{i 2 π \frac{l - 2 m}{N}}$$
where a₀, a1ᵢⱼ, a2ᵢⱼ, . . . are neighboring pixel correlation coefficients, N is a number of pixels and l is a number of Fourier components in an x direction and m is a number of Fourier components in a y direction.

11. The system of claim 8, wherein the asymmetric PSF data further comprises PSF data wherein data values located around a central pixel of the PSF data each have different values.

12. The system of claim 8, wherein the at least one processing device is further configured to:
determine a pixel value for each pixel of the detected image using MNNPD; and
apply the determined pixel value for each pixel to an associated pixel of the detected image.

13. The system of claim 12, wherein the at least one processing device is further configured to generate the processed image responsive to the pixel value applied to each associated pixel of the detected image.

14. The system of claim 8, wherein the at least one processing device is further configured to display the processed image having the increased resolution.

15. A non-transitory machine readable medium containing instructions that when executed cause at least one processor to:
receive a detected image distorted by environmental conditions;
obtain asymmetric point spread function (PSF) data associated with the detected image;
apply modified nearest neighbor pixel deconvolution (MNNPD) to detected image responsive to the asymmetric PSF data; and
generate a processed image from the detected image modified to limit distortion of the detected image and having an increased resolution responsive to the applied MNNPD.

16. The non-transitory machine readable medium of claim 15, further containing instructions that when executed cause the at least one processor to determine the PSF data for each pixel responsive to the MNNPD.

17. The non-transitory machine readable medium of claim 15, further containing instructions that when executed cause the at least one processor to:
apply the MNNPD according to a formula:
$${Δ}_{lm} = {a}_{0} + {Δ}_{lm} ( 1 ) + {Δ}_{lm} ( 2 ) + {Δ}_{lm} ( 3 ) + {Δ}_{lm} ( 4 ) + …$$
$$where :$$
$${Δ}_{lm} ( 1 ) = a {1}_{1 , 0} {e}^{- i 2 π \frac{l}{N}} + a {1}_{0 , 1} {e}^{- i 2 π \frac{m}{N}} + a {1}_{- 1 , 0} {e}^{i 2 π \frac{l}{N}} + a {1}_{0 , - 1} {e}^{i 2 π \frac{m}{N}}$$
$${Δ}_{lm} ( 2 ) = a {2}_{1 , 1} {e}^{- i 2 π \frac{l + m}{N}} + a {2}_{- 1 , - 1} {e}^{i 2 π \frac{l + m}{N}} + a {2}_{1 , - 1} {e}^{- i 2 π \frac{l - m}{N}} + a {2}_{- 1 , 1} {e}^{i 2 π \frac{l - m}{N}}$$
$${Δ}_{lm} ( 3 ) = a {3}_{2 , 0} {e}^{- i 2 π \frac{2 l}{N}} + a {3}_{0 , 2} {e}^{- i 2 π \frac{2 m}{N}} + a {3}_{- 2 , 0} {e}^{i 2 π \frac{2 l}{N}} + a {3}_{0 , - 2} {e}^{i 2 π \frac{2 m}{N}}$$
$${Δ}_{lm} ( 4 ) = a {4}_{2 , 1} {e}^{- i 2 π \frac{2 l + m}{N}} + a {4}_{1 , 2} {e}^{- i 2 π \frac{2 l + m}{N}} + a {4}_{- 2 , - 1} {e}^{i 2 π \frac{2 l + m}{N}} + a {4}_{- 1 , - 2} {e}^{i 2 π \frac{l + 2 m}{N}} + a {4}_{2 , - 1} {e}^{- i 2 π \frac{2 l - m}{N}} + a {4}_{1 , - 2} {e}^{- i 2 π \frac{l - 2 m}{N}} + a {4}_{- 2 , 1} {e}^{i 2 π \frac{2 l - m}{N}} + a {4}_{- 1 , 2} {e}^{i 2 π \frac{l - 2 m}{N}}$$
where a₀, a1ᵢⱼ, a2ᵢⱼ, . . . are neighboring pixel correlation coefficients, N is a number of pixels and l is a number of Fourier components in an x direction and m is a number of Fourier components in a y direction.

18. The non-transitory machine readable medium of claim 15, further containing instructions that when executed cause the at least one processor to:
determine a pixel value for each pixel of the detected image using MNNPD; and
apply the determined pixel value for each pixel to an associated pixel of the detected image.

19. The non-transitory machine readable medium of claim 18, further containing instructions that when executed cause the at least one processor to generate the processed image responsive to the pixel value applied to each associated pixel of the detected image.

20. The non-transitory machine readable medium of claim 15, further containing instructions that when executed cause the at least one processor to display the processed image having the increased resolution.
